(19) United States
(12) Patent Application Publication
(10) Pub. No.: US 2023/0080069 A1
(43) Pub. Date: Mar. 16, 2023

(54) FLOW-CELL DESIGNS FOR BIOLOGICAL IMAGING

(71) Applicant: Applied Materials, Inc., Santa Clara, CA (US)

(72) Inventors: Tze Howe Charn, Singapore (SG); Jan Hendrik Bolte, Vriezenveen (NL); Jan Wiebe Eilander, Hengelo (NL); Anne Freerk de Jager, Hengelo (NL); Roel Penterman, Hengelo (NL)

(73) Assignee: Applied Materials, Inc., Santa Clara, CA (US)

(21) Appl. No.: 17/940,171

(22) Filed: Sep. 8, 2022

Related U.S. Application Data
(60) Provisional application No. 63/243,620, filed on Sep. 13, 2021.

(51) Int. Cl. G01N 15/14; G01N 1/31

(52) U.S. Cl. CPC G01N 15/1404; G01N 15/1434; G01N 1/312; G01N 2015/1006

(57) ABSTRACT

Exemplary flow-cells used in biological imaging may include a coverslip. The flow-cells may include a gasket that is positionable atop the coverslip. The gasket may define an open interior. The flow-cells may include a top plate that is positionable above the gasket and the coverslip. The top plate may define a fluid inlet that is in fluid communication with a first end of the open interior and a fluid outlet that is in fluid communication with a second end of the open interior opposite the first end. The flow-cells may include a clamping mechanism that compresses the gasket between the coverslip and the top plate against the to form a fluid region between the top plate and the coverslip and within the open interior of the gasket.

### CROSS-REFERENCE TO RELATED APPLICATIONS

This application claims the benefit of, and priority to U.S. Provisional Application Ser. No. 63/243,620, filed Sep. 13, 2021, which is hereby incorporated by reference in its entirety for all purposes.

### TECHNICAL FIELD

The present technology relates to components and apparatuses for biological imaging. More specifically, the present technology relates to flow-cells that provide proper reagent flow characteristics for improved imaging of tissue samples.

### BACKGROUND OF THE INVENTION

Biological imaging techniques, and particularly those for imaging mRNA, require significant amounts of time to prepare and image the samples. In some instances, the entire process may span multiple days. Some techniques may require the mRNA to be extracted and/or otherwise dissociated from the tissue prior to imaging, which may introduce additional complex and time consuming steps. Therefore, it may be preferable to image the mRNA in situ. To facilitate the in situ imaging of a tissue sample, the sample may be placed in a flow-cell that enables a reagent to be flowed about the tissue sample prior to imaging the sample. However, the tissue samples are often fragile at the high resolution level, and therefore the flow of reagents must be carefully controlled to prevent damage to the tissue. Additionally, conventional flow-cell designs are complex, and may include many components that may introduce significant opportunity for user error that may lead to issues with the imaging process.

Thus, there is a need for simple flow-cell designs and components that can be used to produce high quality images in all conditions. These and other needs are addressed by the present technology.

### BRIEF SUMMARY OF THE INVENTION

Exemplary flow-cells used in biological imaging may include a coverslip. The flow-cells may include a gasket that is positionable atop the coverslip. The gasket may define an open interior. The flow-cells may include a top plate that is positionable above the gasket and the coverslip. The top plate may define a fluid inlet that is in fluid communication with a first end of the open interior and a fluid outlet that is in fluid communication with a second end of the open interior opposite the first end. The flow-cells may include a clamping mechanism that compresses the gasket between the coverslip and the top plate against the to form a fluid region between the top plate and the coverslip and within the open interior of the gasket.

In some embodiments, the clamping mechanism may include a mechanical clamp. The mechanical clamp may include a lid that is pivotable relative to the top plate to compress the flow-cell. The clamping mechanism may include a vacuum clamp. The flow-cells may include an outer gasket disposed outward of and encircling the gasket. The top plate may define one or more vacuum ports that are coupleable with a negative pressure source. Each of the one or more vacuum ports may be disposed between the gasket and the outer gasket. The flow-cells may include a bottom plate disposed beneath the coverslip. The bottom plate may define a central recess that receives the coverslip, the gasket, and the top plate. The central recess may include at least one alignment feature that ensure that at least one of the coverslip, the gasket, and the top plate are properly oriented within the central recess. The at least one alignment feature may ensure that the fluid inlet is aligned with the first end of the open interior and the fluid outlet is aligned with the second end of the open interior. A width of the fluid region may be greater within a medial portion of the fluid region than near the first end and the second end. A lower surface of the top plate may include one or more phase guides.

Some embodiments of the present technology may encompass flow-cells used in biological imaging. The flow-cells may include a coverslip. The flow-cells may include a top plate that is positionable over the coverslip. A medial portion of the top plate may define a portion of a fluid region of the flow-cell. The top plate may define a fluid inlet that is fluidly coupled with a first end of the fluid region and a fluid outlet that is fluidly coupled with a second end of the fluid region opposite the first end. The flow-cells may include a biocompatible adhesive layer disposed on a bottom surface of the top plate.

In some embodiments, the top plate may include an optically transparent material. A height of the biocompatible adhesive layer may be between about 50 microns and 130 microns. The flow-cells may include a release liner covering the biocompatible adhesive layer.

Some embodiments of the present technology may encompass methods of imaging a tissue sample. The methods may include positioning a tissue sample on a coverslip. The methods may include clamping a top plate against the coverslip to compress a gasket between the top plate and the coverslip. The gasket may define an open interior that defines a fluid region. The methods may include flowing a reagent into the fluid region via a fluid inlet. The methods may include imaging the tissue sample.

In some embodiments, the methods may include flowing the reagent out of the fluid region via a fluid outlet. The methods may include flowing a rinsing agent through the fluid region via the fluid inlet. The methods may include flowing an additional reagent into the fluid region via the fluid inlet. The methods may include imaging the tissue sample an additional time. Clamping the top plate against the coverslip may include using a mechanical clamp to press the top plate against the coverslip. Clamping the top plate against the coverslip may include applying a negative pressure between the top plate and the coverslip via one or more vacuum ports. An outer gasket may be disposed outward of the gasket. The one or more vacuum ports may be disposed between the gasket and the outer gasket.

Such technology may provide numerous benefits over conventional systems and techniques. For example, embodiments of the present technology may include flow-cells that provide improved reagent flow to enable improved in situ imaging of biological samples, and in particular, mRNA in tissue samples. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the drawings.

FIG. 1A shows an exploded isometric view of an exemplary flow-cell according to some embodiments of the present technology.

FIG. 1B shows a schematic side elevation view of the flow-cell of FIG. 1A.

FIG. 1C shows a schematic top view of the flow-cell of FIG. 1A.

FIG. 2A shows an exploded isometric view of an exemplary flow-cell according to some embodiments of the present technology.

FIG. 2B shows a bottom plan view of a top plate and gaskets of the flow-cell of FIG. 2A.

FIG. 3 shows an exploded isometric view of an exemplary flow-cell according to some embodiments of the present technology.

FIG. 4A illustrates an isometric view of an exemplary clamp according to some embodiments of the present technology.

FIG. 4B illustrates a cross-sectional side elevation view of the clamp of FIG. 4A in an open position.

FIG. 4C illustrates a cross-sectional side elevation view of the clamp of FIG. 4A in a partially closed position.

FIG. 4D illustrates a cross-sectional side elevation view of the clamp of FIG. 4A in a closed position.

FIG. 4E illustrates a cross-sectional side elevation view showing a sensor of the clamp of FIG. 4A.

FIG. 5 shows a bottom isometric view of a top plate of the flow-cell of FIG. 3.

FIG. 6 shows operations of an exemplary method of imaging a tissue sample according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION OF THE INVENTION

In situ imaging techniques may utilize flow-cells that enable reagents to be introduced to tissue samples for imaging of mRNA species. Conventional flow-cells may limit a user to using a single reagent for a single tissue sample. Existing flow-cells may involve complex designs including numerous components that must be assembled for each imaging procedure. This may add additional time to the set up process and may create more opportunities for human error, as the components may be difficult to properly align and assemble. This may lead to leaks and/or other issues that may result in poor imaging of the tissue sample. Additionally, conventional flow-cells may not provide proper fluid flow characteristics within a fluid reservoir of the flow-cell. For example, the reagents may not be uniformly distributed within the fluid reservoir, which may occur due to the shape and/or size of the reservoir, as well as the presence of trapped air within the reservoir. Additionally, the shape and/or size of the fluid reservoir may generate flow rates that are too high, which may damage the tissue sample.

The present technology overcomes these challenges by utilizing flow-cell designs that include few components and are quick and easy to align and assemble. Additionally, the flow-cells described herein include flow regions that are designed to promote uniform flow of reagents and other fluids, while also ensuring that the rate of such flow is sufficiently low to prevent the tissue sample from being damaged or displaced. Embodiments may also provide flow-cells that enable in situ imaging of tissue samples over numerous cycles to sample different species of mRNA by utilizing different reagents. Accordingly, the present technology may enable improved in situ imaging of biological samples, while also making the flow-cells easier to use and assemble.

Although the remaining disclosure will routinely identify specific flow-cells utilizing the disclosed technology, it will be readily understood that the systems and methods are equally applicable to other biological imaging systems. Accordingly, the technology should not be considered to be so limited as for use with these specific flow-cells. The disclosure will discuss several possible flow-cell designs according to embodiments of the present technology before additional variations and adjustments to this system according to embodiments of the present technology are described.

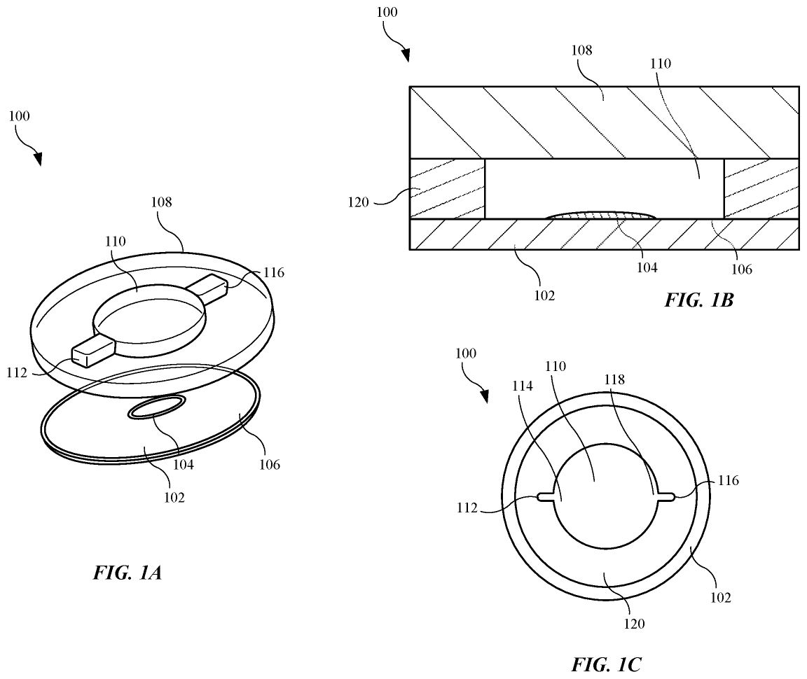

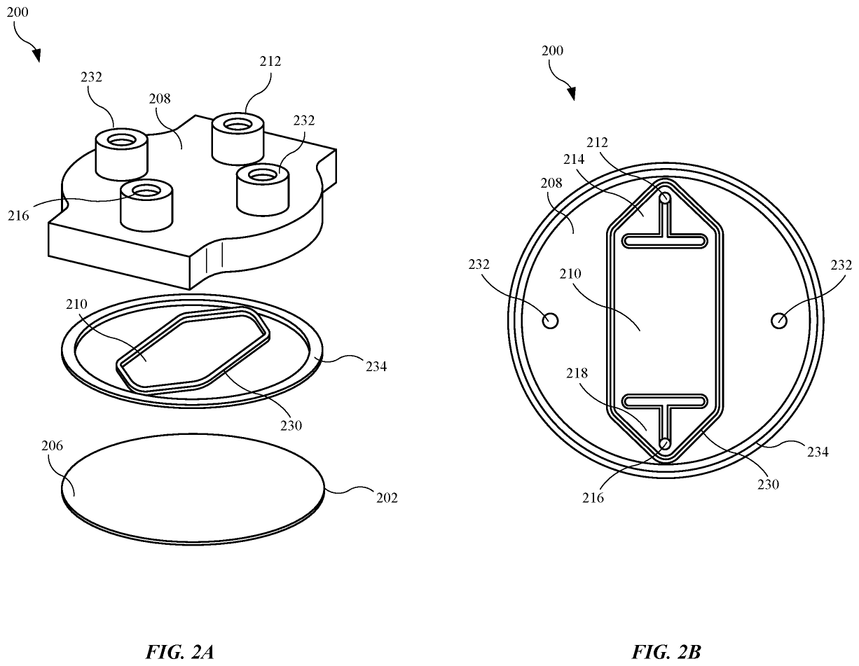

FIGS. 1A-1C illustrate an exemplary embodiment of a flow-cell 100. Flow-cell 100 may include a coverslip 102 that supports a tissue sample 104. For example, the tissue sample 104 may be placed and/or adhered to a central region of a top surface 106 of the coverslip 102. The coverslip 102 may be formed from a non-reactive, transparent material, such as a glass and/or a plastic. In some embodiments, the coverslip 102 may be formed from optical quality glasses, such as soda lime glass or borosilicate glass. The coverslip 102 may have a generally round shape as illustrated here, or may have other shapes, such as generally rectangular shapes. Flow-cell 100 may include a top plate 108 that is positionable over the coverslip 102. Top plate 108 may be formed of an optically transparent material, such as a glass or thermoplastic, which may enable the tissue sample 104 to be illuminated and/or imaged through the top plate 108. In some embodiments, the top plate 108 and the coverslip 102 may be formed from the same material, while in other embodiments the components may be formed from different materials. A medial region of the top plate 108 may define a portion of a fluid region 110 of the flow-cell 100 in some embodiments. The fluid region 110 may define a reservoir through which fluids, such as reagents, may be flowed through the flow-cell 100 to facilitate imaging of the tissue sample 104.

The shape and/or dimensions of the fluid region 110 may be selected to accommodate tissue samples of a given size and/or to produce certain flow characteristics. For example, the fluid region 110 may be sized and shaped to minimize turbulent flow and to maintain a flow rate (which may also be dependent on a viscosity of a particular fluid) through the fluid region 110 within a predefined range. For example, the fluid region 110 may be designed to maintain a flow rate of between about 0.1 mL/min and 3 mL/min for low viscosity fluids (e.g., between or about 0.5 cP and 5 cP) and of 100 μL/min and 1 mL/min for high viscosity fluids (e.g., above or about 5 cP). Such ranges may help ensure that the forces from the fluid flowing through the fluid region 110 (and in particular at the portion of the fluid region 110 in which the tissue sample 104 is disposed) are sufficiently low so as to prevent the fluid from damaging or displacing the tissue sample 104. In some embodiments, to achieve the desired fluid flow rate (and to accommodate the tissue sample 104) the fluid region 110 may have a height of between or about 30 microns and 500 microns, between or about 50 microns and 400 microns, between or about 75 microns and 300 microns, or between or about 100 microns and 200 microns. To enable the flowing of fluids through the fluid region 110, the top plate 108 may define a fluid inlet 112 at a first end 114 of the fluid region 110 and a fluid outlet 116 at a second end 118 of the fluid region 110, with the second end 118 being opposite the first end 114. This may enable a fluid source (not shown) to be interfaced with the fluid inlet 112 to deliver one or more reagents and/or other fluids to the fluid region 110. The medial region of the fluid region 110 may have a width that is greater than at the first end 114 and the second end 118 such that fluid flowing into the fluid region from the fluid inlet 112 expands laterally outward when approaching the tissue sample 104. This lateral expansion of the fluid may help ensure uniform coverage and/or exposure of the tissue sample 104, as well as help reduce the flow rate within the medial region of the fluid region 110.

To secure the top plate 108 with the coverslip 102, a biocompatible adhesive layer 120 may be provided. The biocompatible adhesive layer 120 may be provided in a shape that defines an open interior, which may enable the biocompatible adhesive layer 120 to completely encircle the fluid region 110 and provides a seamless interface between the top plate 108 and coverslip 102 to prevent leakage of any fluids within the flow-cell 100. For example, the biocompatible adhesive layer 120 may have an annular shape, however other shapes with open interiors may be used in various embodiments. The open interior may have any size and shape, and in some embodiments may match the size and shape of the fluid region 110. For example, the open interior may have a shape that is widest in the middle and tapers to narrower widths near ends of the open interior. The biocompatible adhesive layer 120 may include an adhesive material that does not react with the tissue sample 104 and/or any reagents or other fluids that may be flowed into the flow-cell 100. Additionally, the adhesive material may be selected so as to not leech into the fluid region 110 and/or fluids, which may cause background interference, such as background fluorescence. In some embodiments, the adhesive material may include biocompatible film tapes, foam tapes (including PVC foams, polyethylene foams, etc.), hydrocolloid adhesives, and the like. In some embodiments, the biocompatible adhesive layer 120 may be in the form of double-sided tape that may be used to adhere a bottom surface of the top plate 108 with the top surface 106 of the coverslip 102. The biocompatible adhesive layer 120 may be pre-applied to the bottom surface of the top plate 108, which may enable the top plate 108 to be positioned over the coverslip 102 and tissue sample 104. In some embodiments, a release liner may be provided on a bottom surface of the biocompatible adhesive layer 120 to protect the biocompatible adhesive layer 120 prior to coupling the top plate 108 with the coverslip 102. In some embodiments, the biocompatible adhesive layer 120 may be between about 50 microns and 130 microns thick. In some embodiments, the adhesive layer 120 may fully define the lateral boundary of the fluid region 110, with the coverslip 102 and top plate 108 respectively defining the bottom and top boundaries of the fluid region 110. For example, a bottom surface of the top plate 108 may be substantially flat, and the thickness of the adhesive layer 120 may determine the height of the fluid region 110. In such embodiments, the open interior of the adhesive layer 120 may have a shape that is widest in the middle and tapers to narrower widths near ends of the open interior, with ends of the open interior being alignable with the fluid inlet 112 and fluid outlet 116.

In use, the tissue sample 104 may be placed in a medial region of the top surface 106 of the coverslip 102. The top plate 108 may then be adhered to the top surface 106 of the coverslip 102 using biocompatible adhesive layer 120. In some embodiments, this may involve first removing a release layer from the biocompatible adhesive layer 120 prior to coupling the top plate 108 and the coverslip 102. A fluid source may be interfaced with fluid inlet 112 and may introduce a fluid, such as a reagent, into the fluid region 110, where the fluid may flow over and around the tissue sample 104. The tissue sample 104 may be imaged through the top plate 108 and/or coverslip 102, and the fluid may be removed from the fluid region 110 via the fluid outlet 116. In some embodiments, the tissue sample 104 may be imaged multiple times using different reagents. In such embodiments, after a first reagent has been removed from the fluid region, a rinsing and/or bleaching agent may be flowed through the fluid region 110. Then a second reagent may be flowed into the fluid region 110 to facilitate the second imaging sequence. Any number of cycles of rinsing agents and reagents may be used to enable the tissue sample 104 to be imaged any number of times.

FIGS. 2A and 2B illustrate an exemplary flow-cell 200 according to some embodiments of the present technology. FIGS. 2A and 2B may include one or more components discussed above with regard to FIGS. 1A-1C, and may illustrate further details relating to that flow-cell. Flow-cell 200 may include any feature or aspect of flow-cell 100 discussed previously. Flow-cell 200 may include a coverslip 202 having a top surface 206 that may be used to support a tissue sample, which may be similar to tissue sample 104 described above. A gasket 230 may be positioned atop the coverslip 202. The gasket 230 may be formed from a biocompatible material, such as silicone. The gasket 230 may define an open interior that may serve as a fluid region 210 for the flow-cell 200. The gasket 230 may be sized and shaped such that a width of the fluid region 210 is greater within a medial portion of the fluid region 210 than near a first end 214 and a second end 218. As noted above, such a design of the fluid region 210 may enable flow through the fluid region 210 to be generally uniform and at a sufficiently slow rate so as to uniformly expose the tissue sample to fluid while also ensuring that the force of the flowing fluid does not displace the tissue sample from the top surface 206 of the coverslip 202. As illustrated, the first end 214 and second end 218 of the gasket 230 may be generally triangular in shape, while a medial region 222 of the fluid region 210 is generally rectangular, although it will be appreciated that other shapes that deliver the desired flow characteristics (e.g., generally uniform distribution of fluid and desired flow rate) may be utilized in various embodiments.

The flow-cell 200 may include a top plate 208 which may be positionable atop the coverslip 202 and gasket 230. The top plate 208 may be formed of an optically transparent material, such as a glass or plastic, which may enable the tissue sample to be illuminated and/or imaged through the top plate 208. To enable the flowing of fluids through the fluid region 210, the top plate 208 may define a fluid inlet 212 and a fluid outlet 216. When the top plate 208 is positioned over the gasket 230 and the coverslip 202, the fluid inlet 212 may be aligned with the first end 214 of the fluid region 210 and the fluid outlet 216 may be aligned with the second end 218 of the fluid region 210. This may enable a fluid source (not shown) to be interfaced with the fluid inlet 212 to deliver one or more reagents and/or other fluids to the fluid region 210. When positioned atop the coverslip 202 and gasket 230, a portion of a bottom surface of the top plate 208 may form a top boundary of the fluid region 210, while a portion of the top surface 206 of the coverslip 202 forms a bottom boundary of the fluid region 210 and the gasket 230 forms a lateral boundary of the fluid region 210.

Flow-cell 200 may also include a clamping mechanism, which may compress the gasket 230 between the coverslip 202 and the top plate 208 to ensure that the fluid region 210 is sealed to prevent reagents and/or other fluids from leaking out of the fluid region 210. In some embodiments, the clamping mechanism may include a vacuum clamp. For example, the top plate 208 may define one or more vacuum ports 232, which may be coupled with a negative pressure source (not shown). Flow-cell 200 may also include an outer gasket 234, which may be positioned outward of gasket 230 and the vacuum ports 232 such that that vacuum ports 232 are disposed between the gasket 230 and outer gasket 234. This enables the region between the two gaskets to be sealed such that when negative pressure is supplied to the region via the vacuum ports 232, the top plate 208 may be clamped against the gaskets and the coverslip 202. While shown with the outer gasket 234 being circular, it will be appreciated that the outer gasket 234 may be any shape that encircles the gasket 230 while providing space for the vacuum ports 232. Additionally, while illustrated with two vacuum ports 232, it will be appreciated that other number of vacuum ports 232 may be used in various embodiments. For example, the flow-cell 200 may include at least or about 1 vacuum port, at least or about 2 vacuum ports, at least or about 3 vacuum ports, at least or about 4 vacuum ports, at least or about 5 vacuum ports, at least or about 6 vacuum ports, at least or about 7 vacuum ports, at least or about 8 vacuum ports, at least or about 9 vacuum ports, at least or about 10 vacuum ports, or more. In the event that some reagent breaches the gasket 230, the fluid may be sucked up by the vacuum ports 232, which may help prevent spillage of the reagent outside of the flow-cell 200.

A thickness of the compressed gasket 230 may define a height of the fluid region 210. For example, gasket 230 may have a thickness of between or about of between or about 350 microns and 600 microns, between or about 60 microns and 500 microns, between or about 100 microns and 400 microns, or between or about 200 microns and 300 microns. Such a gasket 230 may result in a fluid region 210 that has a height of between or about 30 microns and 500 microns, between or about 50 microns and 400 microns, between or about 75 microns and 300 microns, or between or about 100 microns and 200 microns. Such heights (along with the shape and/or width of the fluid region 210) may help maintain fluid flow rates within the fluid region 210 of between about 0.1 mL/min and 3 mL/min for low viscosity fluids (e.g., between or about 0.5 cP and 5 cP) and of 100 μL/min and 1 mL/min for high viscosity fluids (e.g., above or about 5 cP), which may help ensure that the forces from the fluid flowing through the fluid region 210 (and in particular at the portion of the fluid region 210 in which the tissue sample is disposed) are sufficiently low so as to prevent the fluid from damaging or displacing the tissue sample.

In operation, a tissue sample may be placed in a medial region of the top surface 206 of the coverslip 202. The top plate 208 may then be positioned above the top surface 206 of the coverslip 202 and the gaskets 230, 234. A negative pressure source may be interfaced with the vacuum ports 232 and activated to clamp the top plate 208 against the coverslip 202 and to compress the gaskets 230, 234. A fluid source may be interfaced with fluid inlet 212 and may introduce a fluid, such as a reagent, into the fluid region 210, where the fluid may flow over and around the tissue sample. The tissue sample may be imaged through the top plate 208 and/or coverslip 202, and the fluid may be removed from the fluid region 210 via the fluid outlet 216. In some embodiments, the tissue sample may be imaged multiple times using different reagents. In such embodiments, after a first reagent has been removed from the fluid region, a rinsing agent may be flowed through the fluid region 210. Then a second reagent may be flowed into the fluid region 210 to facilitate the second imaging sequence. Any number of cycles of rinsing agents and reagents may be used to enable the tissue sample to be imaged any number of times.

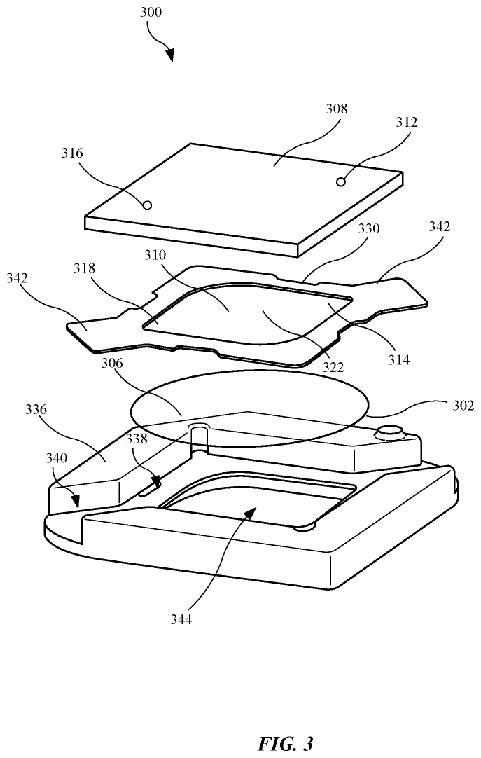

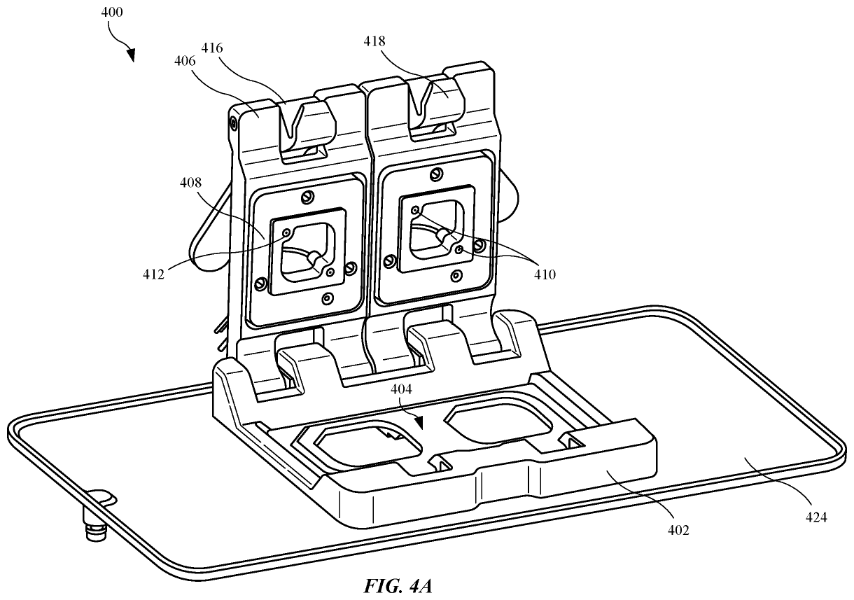

FIG. 3 illustrates an exploded view of an exemplary flow-cell 300 according to some embodiments of the present technology. FIG. 3 may include one or more components discussed above with regard to FIGS. 1A-1C, 2A, and 2B, and may illustrate further details relating to that flow-cell. Flow-cell 300 may include any feature or aspect of flow-cell 100 or 200 discussed previously. Flow-cell 300 may include a coverslip 302 having a top surface 306 that may be used to support a tissue sample, which may be similar to tissue sample 104 described above. A gasket 330 may be positioned atop the coverslip 302. The gasket 330 may be formed from a biocompatible material, such as silicone. The gasket 330 may define an open interior that may serve as a fluid region 310 for the flow-cell 300. The gasket 330 may be sized and shaped such that a width of the fluid region 310 is greater within a medial portion of the fluid region 310 than near a first end 314 and a second end 318. As noted above, such a design of the fluid region 310 may enable flow through the fluid region 310 to be generally uniform and at a sufficiently slow rate so as to uniformly expose the tissue sample to fluid while also ensuring that the force of the flowing fluid does not displace the tissue sample from the top surface 306 of the coverslip 302. As illustrated, the open interior of the gasket 330 may be generally diamond-shaped, with a medial region 322 of the fluid region 310 being wider than ends 314 and 318 of the fluid region 310, although it will be appreciated that other shapes that deliver the desired flow characteristics (e.g., generally uniform distribution of fluid and desired flow rate) may be utilized in various embodiments. In some embodiments, the internal corners of the fluid region 310 may be rounded so as to prevent eddies and/or other turbulent flow from occurring within the fluid region 310.

The flow-cell 300 may include a top plate 308 which may be positionable atop the coverslip 302 and gasket 330. The top plate 308 may be formed of an optically transparent material, such as a glass or plastic, which may enable the tissue sample to be illuminated and/or imaged through the top plate 308. To enable the flowing of fluids through the fluid region 310, the top plate 308 may define a fluid inlet 312 and a fluid outlet 316. When the top plate 308 is positioned over the gasket 330 and the coverslip 302, the fluid inlet 312 may be aligned with the first end 314 of the fluid region 310 and the fluid outlet 316 may be aligned with the second end 318 of the fluid region 310. This may enable a fluid source (not shown) to be interfaced with the fluid inlet 312 to deliver one or more reagents and/or other fluids to the fluid region 310. When positioned atop the coverslip 302 and gasket 330, a portion of a bottom surface of the top plate 308 may form a top boundary of the fluid region 310, while a portion of the top surface 306 of the coverslip 202 forms a bottom boundary of the fluid region 310 and the gasket 330 forms a lateral boundary of the fluid region 310. The fluid region 310 may have a height of between or about 30 microns and 500 microns, between or about 50 microns and 400 microns, between or about 75 microns and 300 microns, or between or about 100 microns and 200 microns. Such heights (along with the shape and/or width of the fluid region 310) may help maintain fluid flow rates within the fluid region 310 of between about 0.1 mL/min and 3 mL/min for low viscosity fluids (e.g., between or about 0.5 cP and 5 cP) and of 100 μL/min and 1 mL/min for high viscosity fluids (e.g., above or about 5 cP), which may help ensure that the forces from the fluid flowing through the fluid region 310 (and in particular at the portion of the fluid region 310 in which the tissue sample is disposed) are sufficiently low so as to prevent the fluid from damaging or displacing the tissue sample.

Flow-cell 300 may include a bottom plate 336 that may be positioned beneath the coverslip 302. The bottom plate 336 may receive and align the top plate 308, gasket 330, and coverslip 302 to ensure that the fluid inlet 312 and fluid outlet 316 are properly aligned with the ends of the fluid region 310. The bottom plate 336 may also serve as a substrate that enables the flow-cell 300 components to be assembled and transported. For example, the bottom plate 336 may define a central recess 338 that receives the coverslip 302, the gasket 330, and the top plate 308. In some embodiments, the central recess 338 may be sized and shaped to help align the various components received therein. For example, a size and shape of the central recess 338 may substantially match outer shapes of one or more of the top plate 308, gasket 330, and the coverslip 302. As illustrated, portions of the outer peripheries of the top plate 308 and gasket 330 have generally rectangular shapes that may closely match (e.g., within or about 10%, within or about 5%, within or about 3%, within or about 1%, or less) dimensions of the central recess 338 to ensure that the components are aligned when inserted into the central recess 338. To further assist with proper alignment of the components, the central recess 338 may include at least one alignment feature that ensures that the coverslip 302, gasket 330, and/or top plate 308 are properly oriented within the central recess 338. For example, as illustrated, two opposing corners of the central recess 338 include notches 340 that extend outward from the central recess 338. One or more of the components received within the central recess 338 may include protrusions that are sized and shaped to fit within the notches 340. For example, in the illustrated embodiment the gasket 330 includes protrusions 342 that are positioned at opposite ends of the gasket 330. The protrusions 342 may be inserted within the notches 340 to properly orient the gasket 330 within the central recess 338. While shown with two notches 340 and/or protrusions 342, it will be appreciated that any number of such alignment features and/or other alignment features may be included on the bottom plate 336 and/or one or more of the components received therein.

In some embodiments, the bottom plate 336 may define a central aperture 344, which may extend through all or a portion of the central recess 338. Central aperture 344 may enable a backside of the flow-cell to be illuminated and/or imaged.

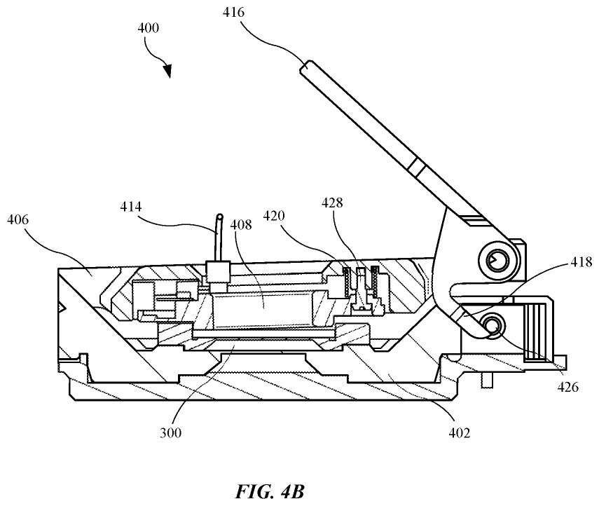

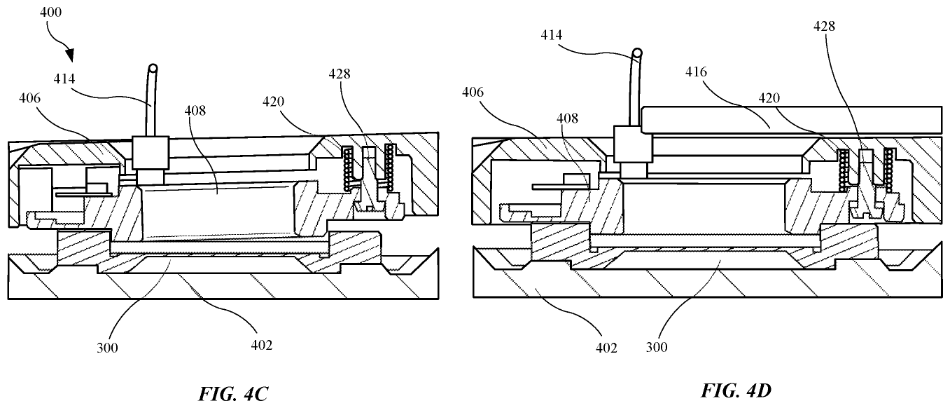

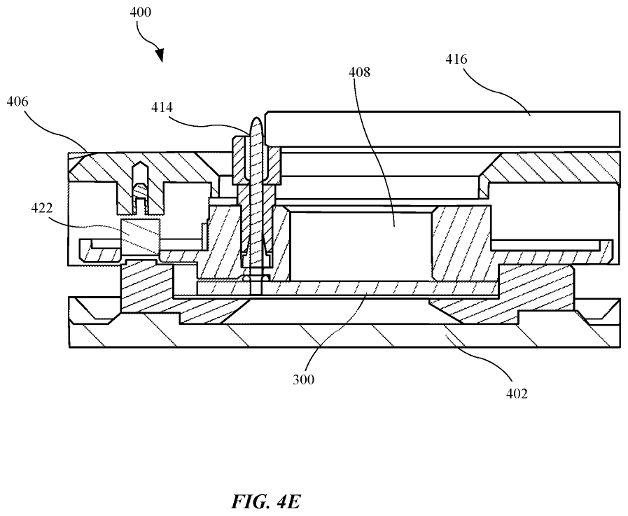

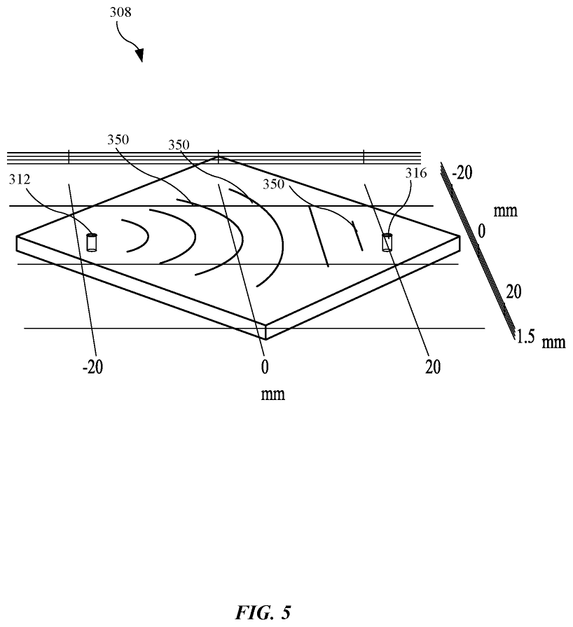

Flow-cell 300 may also include a clamping mechanism, which may compress the gasket 330 between the coverslip 302 and the top plate 308 to ensure that the fluid region 310 is sealed to prevent reagents and/or other fluids from leaking out of the fluid region 310. In some embodiments, the clamping mechanism may include a mechanical clamp. FIGS. 4A-4E illustrate an exemplary mechanical clamp 400 according to embodiments of the invention. Clamp 400 may include a drip tray 402 that may receive the assembled flow-cell 300. The drip tray 402 may define a pocket 404 in which the flow-cell 300 may be placed. The pocket 404 may include a recessed area that is sized to receive the bottom plate 336. The pocket 404 may define a position and height of the flow-cell 300 within an imaging device. Pocket 404 may also define an aperture therethrough that enables a backside of the flow-cell 300 to be illuminated and/or imaged. While illustrated as being able to support two flow-cells 300 side-by-side, it will be appreciated that the drip tray 402 (and the rest of the clamp 400) may be sized to receive any number of flow-cells 300. For example, the clamp 400 may receive at least or about 1 flow-cell, at least or about 2 flow-cells, at least or about 3 flow-cells, at least or about 4 flow-cells, or more.

Clamp 400 may also include a lid 406 that is pivotable relative to the drip tray 402 (and the rest of flow-cell 300, including the top plate 308) to compress the flow-cell 300. For example, the lid 406 may be pivotally coupled with the drip tray 402. In embodiments where the drip tray 402 supports multiple flow-cells 300, each flow-cell 300 may have an independently pivotable lid 406 (as shown here) or multiple of the flow-cells 300 may share a common lid 406. For each flow-cell 300 covered, a given lid 406 may include a pressure plate 408 that may be sized and shaped to engage with a top surface of the top plate 308 of a given flow-cell 300. For example, each pressure plate 408 may include a central region that is sized to fit within the central recess 338 of the flow-cell 300 such that when the lid 406 is lowered, the central region of the pressure plate 408 may press against the top plate 308 to compress the gasket 330 between the top plate 308 and the coverslip 302, thereby sealing the sides of fluid region 310. The pressure plate 408 may include ports 410 that may align with the fluid inlet 312 and fluid outlet 316 of the flow-cell 300 when the lid 406 is closed to enable a fluid source to be coupled with the fluid inlet 312 and fluid outlet 316 of the flow-cell 300. A sealing member 412, such as an O-ring, may be fitted about each of the ports 410 to help seal the interface between the port 410 and the respective one of the fluid inlet 312 and fluid outlet 316.

As illustrated in FIG. 4B, the flow-cell 300 may be positioned within the pocket 404 and the lid 406 may be lowered against a top surface of the flow-cell 300. A fluid source may be interfaced with one of the ports 410 that is aligned with the fluid inlet 312, such as by using a microfluidic connector 414. A lever 416 may be latched to lock the lid 406 in a closed position. For example, a bottom hook 418 of the lever 416 may be positioned beneath a pin or other protrusion 426 formed in the drip tray 402. The lever 416 may be pivoted downward, such as to a more horizontal position, which may enable the hook 418 to slide about a bottom surface of the protrusion 426 to lock the lid 406 in the closed position.

Pressure applied to the flow-cell 300 by the closing of lid 406 may be limited by one or more springs 420. For example, the pressure plate 408 may be secured to the lid 406 using a number of fasteners 428, such as bolts, with pre-tensioned springs 420 being provided at each fastener interface to control the compressive force. As the lid 406 is closed, the preload of the springs 420 is transferred to the flow-cell 300 to supply a pre-set amount of force to the flow-cell 300 to properly compress the gasket 330 to seal the fluid region 310 and to properly compress the sealing members 412 to seal the interface between ports 410 and the fluid inlet 312 and fluid outlet 316. In some embodiments, the preload force of each spring 420 may be selected to provide a predetermined amount of force. This force may be between about 30 N and 100 N in some embodiments, although other values may be possible given the design of a particular flow-cell. The force may be divided up equally for each spring 420. For example, in a given embodiment, each of three springs 420 may have a compression force of 20.5 N such that the total force provided is 61.5 N.

As best illustrated in FIG. 4E, the clamp 400 may include a sensor 422 that may determine when a flow-cell 300 is present within the clamp 400. For example, the sensor 422 may be an induction sensor that may contact a protrusion formed on the bottom plate 336 of the flow-cell 300. The contact between the bottom plate 336 and the sensor 422 may result in the sensor 422 detecting the presence of the flow-cell 300. In some embodiments, the clamp 400 may be disposed on and/or include a spill tray 424, which may collect any fluids that leak out from the flow-cell 300.

In operation, a tissue sample may be placed in a medial region of the top surface 306 of the coverslip 302. The coverslip 302 may be positioned within the bottom plate 336. The top plate 308 and gasket 330 may then be positioned atop the coverslip 302 within the bottom plate 336. The flow-cell 300 may be positioned within the pocket 404 of clamp 400, and a fluid source may be interfaced with a port 410 of the clamp 400. The lever 416 may be actuated to clamp the top plate 308 against the coverslip 302 and a fluid, such as a reagent, may be introduced into the fluid region 310 via the port 410 and fluid inlet 312. The fluid may flow over and around the tissue sample. The tissue sample may be imaged through the top plate 308 and/or coverslip 302, and the fluid may be removed from the fluid region 310 via the fluid outlet 316. In some embodiments, the tissue sample may be imaged multiple times using different reagents. In such embodiments, after a first reagent has been removed from the fluid region, a rinsing agent may be flowed through the fluid region 310. Then a second reagent may be flowed into the fluid region 310 to facilitate the second imaging sequence. Any number of cycles of rinsing agents and reagents may be used to enable the tissue sample to be imaged any number of times.

In some embodiments, air may be trapped within the flow-cell that prevents the reagents or other fluids from flowing uniformly within the fluid region 310. To promote more uniform flow of the reagents and other fluids through the flow-cell 300, a number of phase guides 350 may be utilized. For example, as best illustrated in FIG. 5, a bottom surface of the top plate 308 may incorporate a number of phase guides 350 that may increase and/or decrease the local height of the fluid to promote distribution of the fluid throughout the entire fluid region 310. The phase guides 350 may be provided as ridges and/or grooves formed in the bottom surface of top plate 308. In some embodiments, the phase guides 350 may each be arc-shaped and/or linear in nature, although other shapes are possible in various embodiments. As illustrated, the phase guides 350 include a number of arc-shaped portions (with apexes of each arc position on a downstream side of the flow region 310, although other arrangements are possible in various embodiments) positioned on an inlet side of the top plate 308 and a number of linear portions positioned proximate an outlet side of the top plate 308, with the linear portions being generally transverse to the length of the fluid region 310. In some embodiments, a size (e.g., radius, length, etc.) of the arc-shaped phase guide 350 may increase toward the medial region of the top plate 308, with smaller phase guides 350 positioned nearer the inlet side. The height and/or depth of the phase guides 350 may be less than or about 10 microns, less than or about 8 microns, less than or about 6 microns, less than or about 4 microns, less than or about 2 microns, or less.

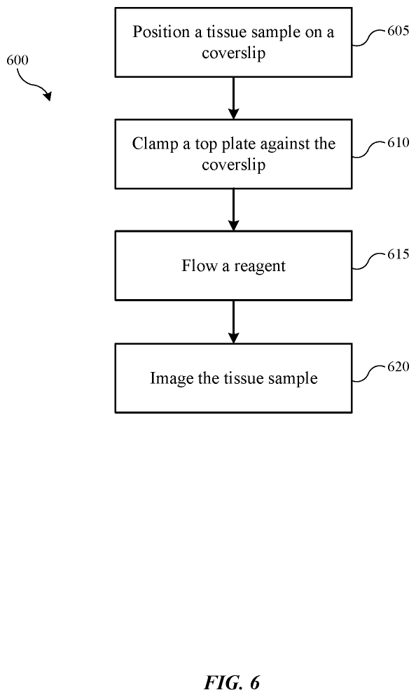

FIG. 6 shows operations of an exemplary method 600 of imaging a tissue sample according to some embodiments of the present technology. The method may be performed using a variety of flow-cells, including flow-cell 200 or 300 described above. Method 600 may include a number of optional operations, which may or may not be specifically associated with some embodiments of methods according to the present technology.

Method 600 may operations performed in different orders than illustrated. Method 600 may include positioning a tissue sample on a coverslip at operation 605. In some embodiments, the tissue sample may be adhered to a medial portion of the coverslip. At operation 610, a top plate may be clamped against the coverslip to compress a gasket between the top plate and the coverslip. For example, the top plate and gasket may be positioned atop the coverslip, with an open interior of the gasket being aligned with the tissue sample. The clamping force may be applied by various clamping mechanisms. For example, a mechanical clamp, such as clamp 400, may be used to clamp the top plate against the coverslip. In other embodiments, a vacuum clamp may be used, such as those described in relation to FIGS. 2A and 2B above. For example, a negative pressure may be applied between the top plate and the coverslip via one or more vacuum ports formed within the top plate. An outer gasket positioned outside of the vacuum ports and gasket may help form a seal to enable the negative pressure to secure the top plate and coverslip together. Once clamped, a reagent may be flowed into a fluid region of the flow-cell via a fluid inlet at operation 615. The tissue sample may be imaged at operation 620.

In some embodiments, the method 600 may optionally include flowing the reagent out of the fluid region via a fluid outlet. A rinsing agent may be flowed through the fluid region via the fluid inlet to rinse the tissue sample to remove the initial reagent. An additional reagent may then be flowed into the fluid region via the fluid inlet and the tissue sample may be imaged an additional time. Such a process may be repeated any number of times for different reagents to enable the tissue sample to be imaged under different conditions.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “an aperture” includes a plurality of such apertures, and reference to “the opening” includes reference to one or more openings and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A flow-cell used in biological imaging, comprising:
a coverslip;
a gasket that is positionable atop the coverslip, the gasket defining an open interior;
a top plate that is positionable above the gasket and the coverslip, wherein the top plate defines a fluid inlet that is in fluid communication with a first end of the open interior and a fluid outlet that is in fluid communication with a second end of the open interior opposite the first end; and
a clamping mechanism that compresses the gasket between the coverslip and the top plate against the to form a fluid region between the top plate and the coverslip and within the open interior of the gasket.

2. The flow-cell used in biological imaging of claim 1, wherein:
the clamping mechanism comprises a mechanical clamp.

3. The flow-cell used in biological imaging of claim 2, wherein:
the mechanical clamp comprises a lid that is pivotable relative to the top plate to compress the flow-cell.

4. The flow-cell used in biological imaging of claim 1, wherein:
the clamping mechanism comprises a vacuum clamp.

5. The flow-cell used in biological imaging of claim 4, further comprising:
an outer gasket disposed outward of and encircling the gasket, wherein:
the top plate defines one or more vacuum ports that are coupleable with a negative pressure source; and
each of the one or more vacuum ports is disposed between the gasket and the outer gasket.

6. The flow-cell used in biological imaging of claim 1, further comprising:
a bottom plate disposed beneath the coverslip.

7. The flow-cell used in biological imaging of claim 6, wherein:
the bottom plate defines a central recess that receives the coverslip, the gasket, and the top plate.

8. The flow-cell used in biological imaging of claim 7, wherein:
the central recess comprises at least one alignment feature that ensure that at least one of the coverslip, the gasket, and the top plate are properly oriented within the central recess.

9. The flow-cell used in biological imaging of claim 8, wherein:
the at least one alignment feature ensures that the fluid inlet is aligned with the first end of the open interior and the fluid outlet is aligned with the second end of the open interior.

10. The flow-cell used in biological imaging of claim 1, wherein:
a width of the fluid region is greater within a medial portion of the fluid region than near the first end and the second end.

11. The flow-cell used in biological imaging of claim 1, wherein:
a lower surface of the top plate comprises one or more phase guides.

12. A flow-cell used in biological imaging, comprising:
a coverslip;
a top plate that is positionable over the coverslip, wherein:
a medial portion of the top plate defines a portion of a fluid region of the flow-cell; and
the top plate defines a fluid inlet that is fluidly coupled with a first end of the fluid region and a fluid outlet that is fluidly coupled with a second end of the fluid region opposite the first end; and
a biocompatible adhesive layer disposed on a bottom surface of the top plate.

13. The flow-cell used in biological imaging of claim 12, wherein:
the top plate comprises an optically transparent material.

14. The flow-cell used in biological imaging of claim 12, wherein:
a height of the biocompatible adhesive layer is between about 50 microns and 130 microns.

15. The flow-cell used in biological imaging of claim 12, further comprising:
a release liner covering the biocompatible adhesive layer.

16. A method of imaging a tissue sample, comprising:
positioning a tissue sample on a coverslip;
clamping a top plate against the coverslip to compress a gasket between the top plate and the coverslip, wherein the gasket defines an open interior that defines a fluid region;
flowing a reagent into the fluid region via a fluid inlet; and
imaging the tissue sample.

17. The method of imaging a tissue sample of claim 16, further comprising:
flowing the reagent out of the fluid region via a fluid outlet;
flowing a rinsing agent through the fluid region via the fluid inlet;
flowing an additional reagent into the fluid region via the fluid inlet; and
imaging the tissue sample an additional time.

18. The method of imaging a tissue sample of claim 16, wherein:
clamping the top plate against the coverslip comprises using a mechanical clamp to press the top plate against the coverslip.

19. The method of imaging a tissue sample of claim 16, wherein:
clamping the top plate against the coverslip comprises applying a negative pressure between the top plate and the coverslip via one or more vacuum ports.

20. The method of imaging a tissue sample of claim 19, wherein:
an outer gasket is disposed outward of the gasket; and
the one or more vacuum ports are disposed between the gasket and the outer gasket.
